(19) United States
(12) Patent Application Publication
(10) Pub. No.: US 2026/0309964 A1
(43) Pub. Date: Oct. 8, 2026

(54) STEREOSCOPIC IMAGING SYSTEM

(71) Applicant: Asia Optical Co., Inc., Taichung (TW)

(72) Inventors: Chih-Peng Wang, Taichung (TW); Ru-Ping Huang, Taichung (TW)

(21) Appl. No.: 19/558,658

(22) Filed: Mar. 6, 2026

(30) Foreign Application Priority Data
Apr. 8, 2025 (TW) 114113185

(51) Int. Cl. G02B 17/08; G03B 35/10

(52) U.S. Cl. CPC G02B 17/08; G03B 35/10

(57) ABSTRACT

A stereoscopic imaging system includes a plurality of reflective surfaces, wherein a first reflective surface faces a second reflective surface and a first incident area is disposed between them; a first light beam passes the first incident area then is incident on the first reflective surface, then is reflected by the first reflective surface and then is incident on the second reflective surface, then is reflected by the second reflective surface and then exits from a first exit area; a third reflective surface faces a fourth reflective surface and a second incident area is disposed between them; a second light beam passes the second incident area and then is incident on the fourth reflective surface, then is reflected by the fourth reflective surface and then is incident on the third reflective surface, then is reflected by the third reflective surface and then exits from a second exit area.

### BACKGROUND OF THE INVENTION

### Field of the Invention

The invention relates to a stereoscopic imaging system.

### Description of the Related Art

The current development trend of a stereoscopic imaging system is toward high resolution. Additionally, the stereoscopic imaging system is developed to have characteristics of miniaturization, longer working distance, and longer back focal length to meet different application needs. However, the known stereoscopic imaging system can't satisfy such requirements. Therefore, the stereoscopic imaging system needs a new structure in order to meet the requirements of high resolution, miniaturization, longer working distance, and longer back focal length at the same time.

### BRIEF SUMMARY OF THE INVENTION

The invention provides a stereoscopic imaging system to solve the above problems. The stereoscopic imaging system is provided with characteristics of an increased resolution, a decreased total length, an increased working distance, an increased back focal length, and still has a good optical performance.

The stereoscopic imaging system in accordance with an exemplary embodiment of the invention includes a plurality of reflective surfaces, wherein a first reflective surface faces a second reflective surface; a first incident area is disposed between the first reflective surface and the second reflective surface, and is close to an object side and away from an image side; a first exit area is disposed between the first incident area and the image side; a first light beam is emitted from the object side passes through the first incident area and then is incident on the first reflective surface, then is reflected by the first reflective surface and then is incident on the second reflective surface, then is reflected by the second reflective surface and then exits from the first exit area, wherein the propagation direction of the first light beam after reflection by the second reflective surface is the same as the propagation direction of the first light beam when it enters the first reflective surface; a third reflective surface faces a fourth reflective surface; a second incident area is disposed between the third reflective surface and the fourth reflective surface, and is close to the object side and away from the image side; a second exit area is disposed between the second incident area and the image side; a second light beam is emitted from the object side passes through the second incident area and then is incident on the fourth reflective surface, then is reflected by the fourth reflective surface and then is incident on the third reflective surface, then is reflected by the third reflective surface and then exits from the second exit area, wherein the propagation direction of the second light beam after reflection by the third reflective surface is the same as the propagation direction of the second light beam when it enters the fourth reflective surface; the first reflective surface is disposed parallel to the second reflective surface; the third reflective surface is disposed parallel to the fourth reflective surface; the second reflective surface intersects with the third reflective surface; and the stereoscopic imaging system satisfies at least one of the following conditions: 16 mm≤L1≤27 mm; 16 mm≤L4≤27 mm; 0.4 degree/mm≤FOV/L1≤1.2 degree/mm; 19 mm≤(L1×L2)/WD≤52 mm; 1.1≤L2/L1≤1.6; wherein L1 is a shortest interval between an object side end of the first reflective surface and an object side end of the second reflective surface, L2 is a shortest interval between the object side end of the first reflective surface and an image side end of the first reflective surface, L4 is a shortest interval between the image side end of the first reflective surface and an image side end of the second reflective surface, FOV is a field of view of the stereoscopic imaging system, and WD is a shortest interval between a first stop and the first incident area.

In another exemplary embodiment, the first reflective surface includes a first point, a second point, a third point, and a fourth point; the second reflective surface includes a fifth point, a sixth point, a seventh point, and an eighth point; the first point, the fifth point, the seventh point, and the third point form the first incident area, and the second point, the sixth point, the eighth point, and the fourth point form the first exit area; the third reflective surface includes a ninth point, a tenth point, an eleventh point, and a twelfth point; the fourth reflective surface includes a thirteenth point, a fourteenth point, a fifteenth point, and a sixteenth point; the ninth point, the thirteenth point, the fifteenth point, and the eleventh point form the second incident area, and the tenth point, the fourteenth point, the sixteenth point, and the twelfth point form the second exit area.

In yet another exemplary embodiment, the first point and the third point are the same point and the sixth point and the eighth point are the same point, or the fifth point and the seventh point are the same point and the second point and the fourth point are the same point when the first reflective surface and the second reflective surface are planes formed by three points, respectively; and the ninth point and the eleventh point are the same point and the fourteenth point and the sixteenth point are the same point, or the thirteenth point and the fifteenth point are the same point and the tenth point and the twelfth point are the same point when the third reflective surface and the fourth reflective surface are planes formed by three points, respectively.

In another exemplary embodiment, the first reflective surface is formed by a first plane mirror, or by a first surface of a parallelogram prism, or by an inclined surface of a first prism; the second reflective surface is formed by a second plane mirror, or by a second surface of the parallelogram prism, or by an inclined surface of a second prism, or by a beam splitting surface of a beam combining prism; the third reflective surface is formed by a third plane mirror, or by a third surface of another parallelogram prism, or by an inclined surface of a third prism, or by another beam splitting surface of the beam combining prism; and the fourth reflective surface is formed by a fourth plane mirror, or by a fourth surface of the another parallelogram prism, or by an inclined surface of a fourth prism.

The stereoscopic imaging system in accordance with another exemplary embodiment of the invention includes a plurality of prisms, wherein a first prism includes a first surface, a second surface, and a third surface; a second prism includes a fourth surface, a fifth surface, and a sixth surface; a third prism includes a seventh surface, an eighth surface, and a ninth surface; a fourth prism includes a tenth surface, an eleventh surface, and a twelfth surface; a fifth prism includes a thirteenth surface, a fourteenth surface, and a fifteenth surface; the first surface of the first prism forms the first incident area, the thirteenth surface of the fifth prism forms the second incident area, and the eighth surface of the third prism forms an exit area; the third surface of the first prism connects the fifth surface of the second prism, the sixth surface of the second prism connects the seventh surface of the third prism, the ninth surface of the third prism connects the eleventh surface of the fourth prism, and the twelfth surface of the fourth prism connects the fourteenth surface of the fifth prism; a first reflective surface is formed by the second surface of the first prism; a second reflective surface is formed by the fourth surface of the second prism and the ninth surface of the third prism, or by the fourth surface of the second prism and the eleventh surface of the fourth prism; a third reflective surface is formed by the sixth surface of the second prism and the tenth surface of the fourth prism, or by the seventh surface of the third prism and the tenth surface of the fourth prism; a fourth reflective surface is formed by the fifteenth surface of the fifth prism; a first light beam is emitted from the object side passes through the first incident area and then is incident on the first reflective surface, then is reflected by the first reflective surface and then is incident on the second reflective surface, then is reflected by the second reflective surface and then exits from the exit area, wherein the propagation direction of the first light beam after reflection by the second reflective surface is the same as the propagation direction of the first light beam when it enters the first reflective surface; and a second light beam is emitted from the object side passes through the second incident area and then is incident on the fourth reflective surface, then is reflected by the fourth reflective surface and then is incident on the third reflective surface, then is reflected by the third reflective surface and then exits from the exit area, wherein the propagation direction of the second light beam after reflection by the third reflective surface is the same as the propagation direction of the second light beam when it enters the fourth reflective surface.

In another exemplary embodiment, the stereoscopic imaging system further includes a sixth prism, wherein the sixth prism includes a sixteenth surface, a seventeenth surface, and an eighteenth surface, wherein the sixteenth surface faces the object side, the seventeenth surface connects the fourth surface of the second prism, and the eighteenth surface connects the tenth surface of the fourth prism; and the second reflective surface is formed by the seventeenth surface and the eleventh surface of the fourth prism and the third reflective surface is formed by the eighteenth surface and the sixth surface of the second prism when the sixth prism is disposed.

The stereoscopic imaging system in accordance with yet another exemplary embodiment of the invention includes a plurality of reflective surfaces, wherein a first reflective surface includes a first point, a second point, a third point, and a fourth point; a second reflective surface includes a fifth point, a sixth point, a seventh point, and an eighth point; the first reflective surface faces the second reflective surface, such that the first point, the fifth point, the seventh point, and the third point form a first incident area, and the second point, the sixth point, the eighth point, and the fourth point form a first exit area; a first light beam is emitted from the object side passes through the first incident area and then is incident on the first reflective surface, then is reflected by the first reflective surface and then is incident on the second reflective surface, then is reflected by the second reflective surface and then exits from the first exit area, wherein the propagation direction of the first light beam after reflection by the second reflective surface is the same as the propagation direction of the first light beam when it enters the first reflective surface; the third reflective surface includes a ninth point, a tenth point, an eleventh point, and a twelfth point; the fourth reflective surface includes a thirteenth point, a fourteenth point, a fifteenth point, and a sixteenth point; the third reflective surface faces the fourth reflective surface, such that the ninth point, the thirteenth point, the fifteenth point, and the eleventh point form a second incident area, and the tenth point, the fourteenth point, the sixteenth point, and the twelfth point form a second exit area; a second light beam is emitted from the object side passes through the second incident area and then is incident on the fourth reflective surface, then is reflected by the fourth reflective surface and then is incident on the third reflective surface, then is reflected by the third reflective surface and then exits from the second exit area, wherein the propagation direction of the second light beam after reflection by the third reflective surface is the same as the propagation direction of the second light beam when it enters the fourth reflective surface; the first reflective surface is disposed parallel to the second reflective surface; the third reflective surface is disposed parallel to the fourth reflective surface; and an end of the second reflective surface includes the sixth point and the eighth point, an end of the third reflective surface includes a tenth point and the twelfth point, the sixth point connects the tenth point, the eighth point connects the twelfth point, and another end of the second reflective surface includes the fifth point and the seventh point and is disposed away from the third reflective surface.

In another exemplary embodiment, the first reflective surface and the second reflective surface are respectively a first surface and a second surface of a first prism, wherein the first prism further includes a fifth surface and a sixth surface, the first surface faces the second surface, the fifth surface faces the sixth surface, the fifth surface forms the first incident area, and the sixth surface forms the first exit area; and the third reflective surface and the fourth reflective surface are respectively a third surface and a fourth surface of a second prism, wherein the second prism further includes a seventh surface and an eighth surface, the third surface faces the fourth surface, the seventh surface faces the eighth surface, the seventh surface forms the second incident area, the eighth surface forms the second exit area, and the eighth surface is adjacent to the sixth surface.

The stereoscopic imaging system in accordance with another exemplary embodiment of the invention includes a plurality of prisms and a plurality of reflective surfaces, wherein a first prism includes a second surface, a third surface, and a fourth surface; a second prism includes a fifth surface, a sixth surface, and a seventh surface; a third prism includes an eighth surface, a ninth surface, and a tenth surface; a first reflective surface is a plane mirror and includes a first surface, wherein an end of the first surface connects the first prism and another end of the first reflective surface is away from the first prism; the second surface of the first prism and the seventh surface of the second prism forms a second reflective surface, or the second surface of the first prism and the ninth surface of the third prism forms a second reflective surface; the eighth surface of the third prism and the fourth surface of the first prism forms a third reflective surface, or the eighth surface of the third prism and the fifth surface of the second prism forms a third reflective surface; a fourth reflective surface is a plane mirror and includes an eleventh surface, wherein an end of the eleventh surface connects the third prism and another end of the fourth reflective surface is away from the third prism; a first incident area is disposed between the first reflective surface and the second reflective surface, and is close to an object side and away from an image side; a second incident area is disposed between the third reflective surface and the fourth reflective surface, and is close to the object side and away from the image side; the sixth surface of the second prism forms an exit area; the fourth surface of the first prism connects the fifth surface of the second prism, and the seventh surface of the second prism connects the ninth surface of the third prism; a first light beam is emitted from the object side passes through the first incident area and then is incident on the first reflective surface, then is reflected by the first reflective surface and then is incident on the second reflective surface, then is reflected by the second reflective surface and then exits from the exit area, wherein the propagation direction of the first light beam after reflection by the second reflective surface is the same as the propagation direction of the first light beam when it enters the first reflective surface; and a second light beam is emitted from the object side passes through the second incident area and then is incident on the fourth reflective surface, then is reflected by the fourth reflective surface and then is incident on the third reflective surface, then is reflected by the third reflective surface and then exits from the exit area, wherein the propagation direction of the second light beam after reflection by the third reflective surface is the same as the propagation direction of the second light beam when it enters the fourth reflective surface.

In another exemplary embodiment, the stereoscopic imaging system further includes a fourth prism, wherein the fourth prism includes a twelfth surface, a thirteenth surface, and a fourteenth surface, wherein the twelfth surface faces the object side, the thirteenth surface connects the second surface of the first prism, and the fourteenth surface connects the eighth surface of the third prism; and the second reflective surface is formed by the thirteenth surface and the ninth surface of the third prism, and the third reflective surface is formed by the fourteenth surface and the fourth surface of the second prism when the fourth prism is disposed.

In yet another exemplary embodiment, the stereoscopic imaging system satisfies at least one of following conditions: 16 mm≤L1≤27 mm; 16 mm≤L4≤27 mm; 0.4 degree/mm≤FOV/L1≤1.2 degree/mm; 19 mm≤(L1×L2)/WD≤52 mm; 1.1≤L2/L1≤1.6; wherein L1 is a shortest interval between an object side end of the first reflective surface and an object side end of the second reflective surface, L2 is a shortest interval between the object side end of the first reflective surface and an image side end of the first reflective surface, L4 is a shortest interval between the image side end of the first reflective surface and an image side end of the second reflective surface, FOV is a field of view of the stereoscopic imaging system, and WD is a shortest interval between a first stop and the first incident area.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic diagram of a stereoscopic imaging system in accordance with a first embodiment of the invention;

FIG. 2 is a partial schematic diagram of the stereoscopic imaging system in accordance with the first embodiment of the invention;

FIG. 3 is a schematic diagram of a stereoscopic imaging system in accordance with a second embodiment of the invention;

FIG. 4 is a partial schematic diagram of the stereoscopic imaging system in accordance with the second embodiment of the invention;

FIG. 5 is a partial schematic diagram of a stereoscopic imaging system in accordance with a third embodiment of the invention;

FIG. 6 is a partial schematic diagram of a stereoscopic imaging system in accordance with a fourth embodiment of the invention; and

FIG. 7 is a partial schematic diagram of a stereoscopic imaging system in accordance with a fifth embodiment, a sixth embodiment, and a seventh embodiment.

### DETAILED DESCRIPTION OF THE INVENTION

The following description is made for the purpose of illustrating the general principles of the invention and should not be taken in a limiting sense. The scope of the invention is best determined by reference to the appended claims.

The present invention provides a stereoscopic imaging system including a plurality of reflective surfaces, wherein a first reflective surface faces a second reflective surface; a first incident area is disposed between the first reflective surface and the second reflective surface, and is close to an object side and away from an image side; a first exit area is disposed between the first incident area and the image side; a first light beam is emitted from the object side passes through the first incident area and then is incident on the first reflective surface, then is reflected by the first reflective surface and then is incident on the second reflective surface, then is reflected by the second reflective surface and then exits from the first exit area, wherein the propagation direction of the first light beam after reflection by the second reflective surface is the same as the propagation direction of the first light beam when it enters the first reflective surface; a third reflective surface faces a fourth reflective surface; a second incident area is disposed between the third reflective surface and the fourth reflective surface, and is close to the object side and away from the image side; a second exit area is disposed between the second incident area and the image side; a second light beam is emitted from the object side passes through the second incident area and then is incident on the fourth reflective surface, then is reflected by the fourth reflective surface and then is incident on the third reflective surface, then is reflected by the third reflective surface and then exits from the second exit area, wherein the propagation direction of the second light beam after reflection by the third reflective surface is the same as the propagation direction of the second light beam when it enters the fourth reflective surface; the first reflective surface is disposed parallel to the second reflective surface; the third reflective surface is disposed parallel to the fourth reflective surface; the second reflective surface intersects with the third reflective surface; and the stereoscopic imaging system satisfies at least one of the following conditions: 16 mm≤L1≤27 mm; 16 mm≤L4≤27 mm; 0.4 degree/mm≤FOV/L1≤1.2 degree/mm; 19 mm≤(L1×L2)/WD≤52 mm; 1.1≤L2/L1≤1.6; wherein L1 is a shortest interval between an object side end of the first reflective surface and an object side end of the second reflective surface, L2 is a shortest interval between the object side end of the first reflective surface and an image side end of the first reflective surface, L4 is a shortest interval between the image side end of the first reflective surface and an image side end of the second reflective surface, FOV is a field of view of the stereoscopic imaging system, and WD is a shortest interval between a first stop and the first incident area. The basic function of the stereoscopic imaging system of the present invention can be achieved when the stereoscopic imaging system of the present invention satisfies the above features, and does not require other additional features or conditions.

The present invention provides another stereoscopic imaging system including a plurality of prisms, wherein a first prism includes a first surface, a second surface, and a third surface; a second prism includes a fourth surface, a fifth surface, and a sixth surface; a third prism includes a seventh surface, an eighth surface, and a ninth surface; a fourth prism includes a tenth surface, an eleventh surface, and a twelfth surface; a fifth prism includes a thirteenth surface, a fourteenth surface, and a fifteenth surface; the first surface of the first prism forms the first incident area, the thirteenth surface of the fifth prism forms the second incident area, and the eighth surface of the third prism forms an exit area; the third surface of the first prism connects the fifth surface of the second prism, the sixth surface of the second prism connects the seventh surface of the third prism, the ninth surface of the third prism connects the eleventh surface of the fourth prism, and the twelfth surface of the fourth prism connects the fourteenth surface of the fifth prism; a first reflective surface is formed by the second surface of the first prism; a second reflective surface is formed by the fourth surface of the second prism and the ninth surface of the third prism, or by the fourth surface of the second prism and the eleventh surface of the fourth prism; a third reflective surface is formed by the sixth surface of the second prism and the tenth surface of the fourth prism, or by the seventh surface of the third prism and the tenth surface of the fourth prism; a fourth reflective surface is formed by the fifteenth surface of the fifth prism; a first light beam is emitted from the object side passes through the first incident area and then is incident on the first reflective surface, then is reflected by the first reflective surface and then is incident on the second reflective surface, then is reflected by the second reflective surface and then exits from the exit area, wherein the propagation direction of the first light beam after reflection by the second reflective surface is the same as the propagation direction of the first light beam when it enters the first reflective surface; and a second light beam is emitted from the object side passes through the second incident area and then is incident on the fourth reflective surface, then is reflected by the fourth reflective surface and then is incident on the third reflective surface, then is reflected by the third reflective surface and then exits from the exit area, wherein the propagation direction of the second light beam after reflection by the third reflective surface is the same as the propagation direction of the second light beam when it enters the fourth reflective surface. The basic function of the stereoscopic imaging system of the present invention can be achieved when the stereoscopic imaging system of the present invention satisfies the above features, and does not require other additional features or conditions.

The present invention provides yet another stereoscopic imaging system including a plurality of reflective surfaces, wherein a first reflective surface includes a first point, a second point, a third point, and a fourth point; a second reflective surface includes a fifth point, a sixth point, a seventh point, and an eighth point; the first reflective surface faces the second reflective surface, such that the first point, the fifth point, the seventh point, and the third point form a first incident area, and the second point, the sixth point, the eighth point, and the fourth point form a first exit area; a first light beam is emitted from the object side passes through the first incident area and then is incident on the first reflective surface, then is reflected by the first reflective surface and then is incident on the second reflective surface, then is reflected by the second reflective surface and then exits from the first exit area, wherein the propagation direction of the first light beam after reflection by the second reflective surface is the same as the propagation direction of the first light beam when it enters the first reflective surface; the third reflective surface includes a ninth point, a tenth point, an eleventh point, and a twelfth point; the fourth reflective surface includes a thirteenth point, a fourteenth point, a fifteenth point, and a sixteenth point; the third reflective surface faces the fourth reflective surface, such that the ninth point, the thirteenth point, the fifteenth point, and the eleventh point form a second incident area, and the tenth point, the fourteenth point, the sixteenth point, and the twelfth point form a second exit area; a second light beam is emitted from the object side passes through the second incident area and then is incident on the fourth reflective surface, then is reflected by the fourth reflective surface and then is incident on the third reflective surface, then is reflected by the third reflective surface and then exits from the second exit area, wherein the propagation direction of the second light beam after reflection by the third reflective surface is the same as the propagation direction of the second light beam when it enters the fourth reflective surface; the first reflective surface is disposed parallel to the second reflective surface; the third reflective surface is disposed parallel to the fourth reflective surface; and an end of the second reflective surface includes the sixth point and the eighth point, an end of the third reflective surface includes a tenth point and the twelfth point, the sixth point connects the tenth point, the eighth point connects the twelfth point, and another end of the second reflective surface includes the fifth point and the seventh point and is disposed away from the third reflective surface. The basic function of the stereoscopic imaging system of the present invention can be achieved when the stereoscopic imaging system of the present invention satisfies the above features, and does not require other additional features or conditions.

The present invention provides another stereoscopic imaging system including a plurality of prisms and a plurality of reflective surfaces, wherein a first prism includes a second surface, a third surface, and a fourth surface; a second prism includes a fifth surface, a sixth surface, and a seventh surface; a third prism includes an eighth surface, a ninth surface, and a tenth surface; a first reflective surface is a plane mirror and includes a first surface, wherein an end of the first surface connects the first prism and another end of the first reflective surface is away from the first prism; the second surface of the first prism and the seventh surface of the second prism forms a second reflective surface, or the second surface of the first prism and the ninth surface of the third prism forms a second reflective surface; the eighth surface of the third prism and the fourth surface of the first prism forms a third reflective surface, or the eighth surface of the third prism and the fifth surface of the second prism forms a third reflective surface; a fourth reflective surface is a plane mirror and includes an eleventh surface, wherein an end of the eleventh surface connects the third prism and another end of the fourth reflective surface is away from the third prism; a first incident area is disposed between the first reflective surface and the second reflective surface, and is close to an object side and away from an image side; a second incident area is disposed between the third reflective surface and the fourth reflective surface, and is close to the object side and away from the image side; the sixth surface of the second prism forms an exit area; the fourth surface of the first prism connects the fifth surface of the second prism, and the seventh surface of the second prism connects the ninth surface of the third prism; a first light beam is emitted from the object side passes through the first incident area and then is incident on the first reflective surface, then is reflected by the first reflective surface and then is incident on the second reflective surface, then is reflected by the second reflective surface and then exits from the exit area, wherein the propagation direction of the first light beam after reflection by the second reflective surface is the same as the propagation direction of the first light beam when it enters the first reflective surface; and a second light beam is emitted from the object side passes through the second incident area and then is incident on the fourth reflective surface, then is reflected by the fourth reflective surface and then is incident on the third reflective surface, then is reflected by the third reflective surface and then exits from the exit area, wherein the propagation direction of the second light beam after reflection by the third reflective surface is the same as the propagation direction of the second light beam when it enters the fourth reflective surface. The basic function of the stereoscopic imaging system of the present invention can be achieved when the stereoscopic imaging system of the present invention satisfies the above features, and does not require other additional features or conditions.

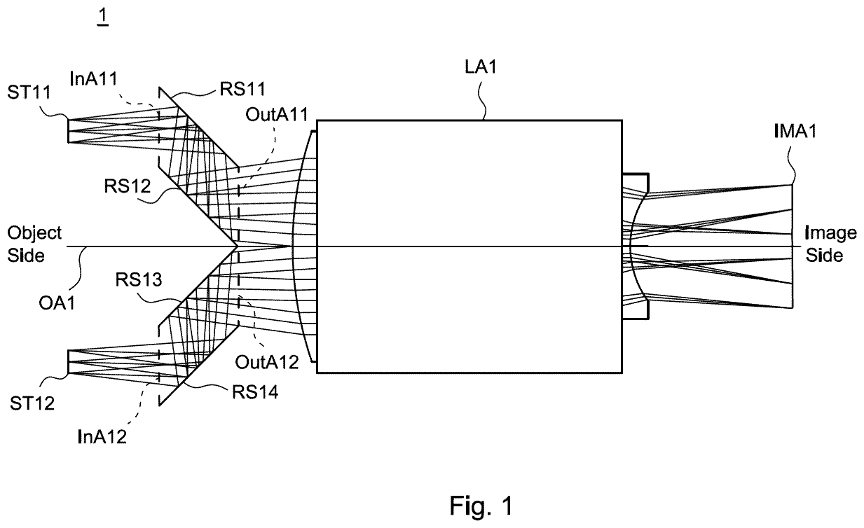

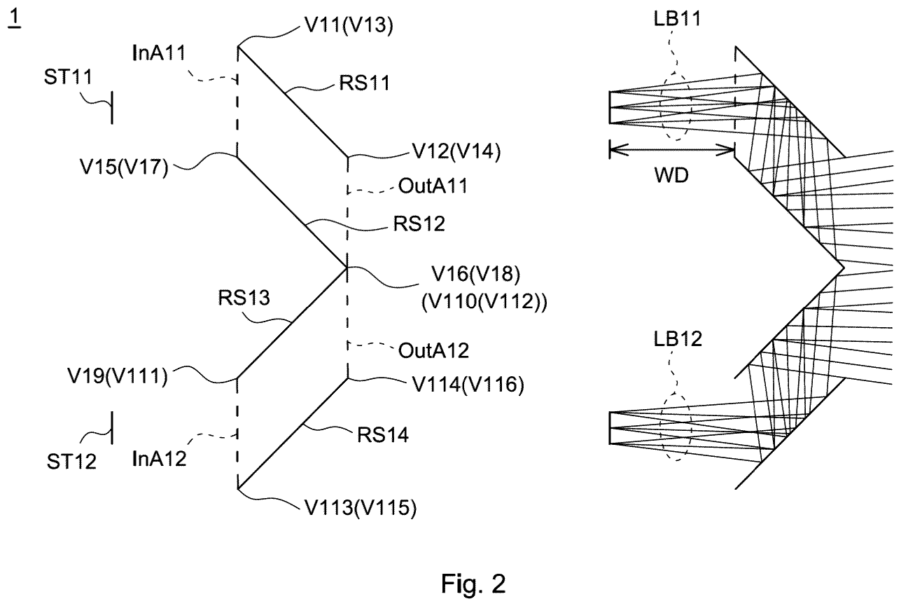

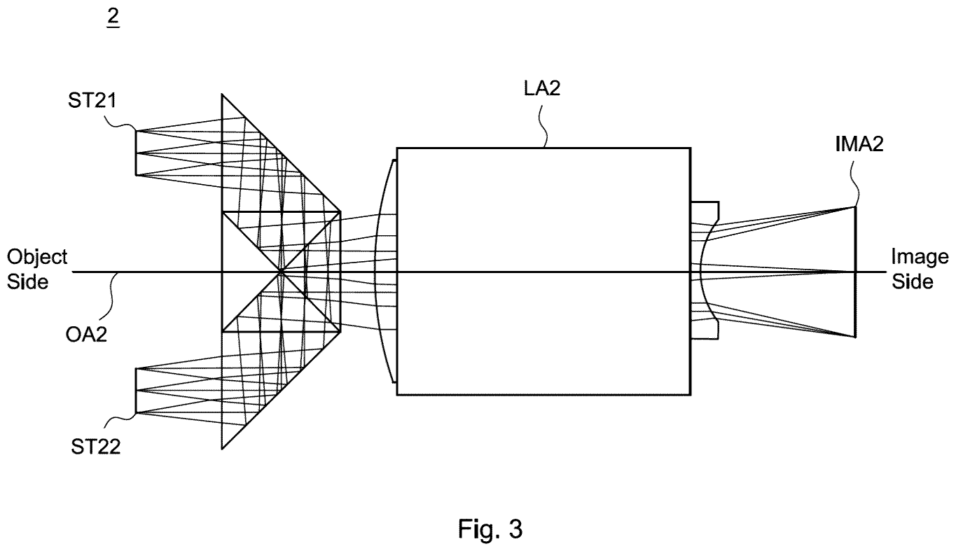

Referring to FIG. 1 and FIG. 3, wherein FIG. 1 and FIG. 3 are schematic diagrams of a stereoscopic imaging system in accordance with a first and a second embodiments of the invention, respectively. FIGS. 2, 4, 5, 6, and 7 are partial schematic diagrams of a stereoscopic imaging system in accordance with the first, the second, the third, the fourth, the fifth, the sixth, and the seventh embodiments of the invention, respectively. Although some element symbols of the fifth, the sixth, and the seventh embodiments of the invention are omitted. However, in the following content concerning the fifth, the sixth, and the seventh embodiments, the element symbols of the fifth, the sixth, and the seventh embodiments will continue to be used for ease of explanation.

The stereoscopic imaging systems 1, 2, 3, 4, 5, 6, and 7 satisfy at least one of the following conditions:

$$16 mm \leq L 1 \leq 27 mm ; \qquad ( 1 )$$

$$16 mm \leq L 4 \leq 27 mm ; \qquad ( 2 )$$

$$19 mm \leq ( L 1 \times L 2 ) / WD \leq 52 mm ; \qquad ( 3 )$$

$$0.4 degree / mm \leq FOV / L 1 \leq 1.2 degree / mm ; \qquad ( 4 )$$

$$1.1 \leq L 2 / L 1 \leq 1.6 ; \qquad ( 5 )$$

wherein L1 is a shortest interval between an object side end of the first reflective surface RS11 and an object side end of the second reflective surface RS12, L2 is a shortest interval between the object side end of the first reflective surface RS11 and an image side end of the first reflective surface RS11, L4 is a shortest interval between the image side end of the first reflective surface RS11 and an image side end of the second reflective surface RS12, FOV is a field of view of the stereoscopic imaging system 1, 2, 3, 4, 5, 6, 7, and WD is a shortest interval between the first stops ST11, ST21, ST31, ST41, ST51, ST61, ST71 and the first incident areas InA11, InA12, InA13, InA14, InA15, InA16, InA17. Making the stereoscopic imaging system 1, 2, 3, 4, 5, 6, 7 increasing the working distance effectively, increasing the back focal length effectively, and reducing the volume effectively.

The terms first, second, third, fourth, fifth, sixth, seventh, eighth, ninth, tenth, eleventh, twelfth, thirteenth, fourteenth, fifteenth, sixteenth, seventeenth, and eighteenth used in the following embodiments are only used to distinguish elements and are not intended to order or limit the number of elements.

A detailed description of a stereoscopic imaging system in accordance with a first embodiment of the invention is as follows. Referring to FIG. 1 and FIG. 2, the stereoscopic imaging system 1 includes a first stop ST11, a second stop ST12, a first reflective surface RS11, a second reflective surface RS12, a third reflective surface RS13, a fourth reflective surface RS14, and a lens assembly LA1, all of which are arranged in order from an object side to an image side along an optical axis OA1. The first reflective surface RS11 can be a first plane mirror. The second reflective surface RS12 can be a second plane mirror. The third reflective surface RS13 can be a third plane mirror. The fourth reflective surface RS14 can be a fourth plane mirror. The first reflective surface RS11 and the fourth reflective surface RS14 are disposed on both sides of the optical axis OA1, wherein the optical axis OA1 is the axis of symmetry. The second reflective surface RS12 and the third reflective surface RS13 are disposed on both sides of the optical axis OA1, wherein the optical axis OA1 is the axis of symmetry. The first reflective surface RS11 and the second reflective surface RS12 are disposed on one side of the optical axis OA1, and the third reflective surface RS13 and the fourth reflective surface RS14 are disposed on the other side of the optical axis OA1. The first reflective surface RS11 includes a first point V11, a second point V12, a third point V13, and a fourth point V14. The second reflective surface RS12 includes a fifth point V15, a sixth point V16, a seventh point V17, and an eighth point V18. The first reflective surface RS11 faces the second reflective surface RS12. The first point V11, the fifth point V15, the seventh point V17, and the third point V13 form a first incident area InA11. The second point V12, the sixth point V16, the eighth point V18, and the fourth point V14 form a first exit area OutA11. The third reflective surface RS13 includes a ninth point V19, a tenth point V110, an eleventh point V111, and a twelfth point V112. The fourth reflective surface RS14 includes a thirteenth point V113, a fourteenth point V114, a fifteenth point V115, and a sixteenth point V116. The third reflective surface RS13 faces the fourth reflective surface RS14. The ninth point V19, the thirteenth point V113, the fifteenth point V115, and the eleventh point VIII form a second incident area InA12. The tenth point V110, the fourteenth point V114, the sixteenth point V116, and the twelfth point V112 form a second exit area OutA12. The lens assembly LA1 can be (but not limited to) the lens assembly disclosed in patent numbers TW 1668480, TW I655472, TW I861437, TW I861361, TW I522645, TW I852638, CN 114911026, CN 105759399, CN 101241224, U.S. Pat. Nos. 11,243,378, and 7,477,459. In operation, an object (not shown) is disposed on the object side emitting a first light beam LB11. The first light beam LB11 passes sequentially through the first stop ST11 and the first incident area InA11, and then is incident on the first reflective surface RS11. The first reflective surface RS11 reflects the first light beam LB11, so that the first light beam LB11 is incident on the second reflective surface RS12. The second reflective surface RS12 reflects the first light beam LB11, so that the first light beam LB11 exits from the first exit area OutA11. The propagation direction of the first light beam LB11 after being reflected by the second reflective surface RS12 is the same as the propagation direction of the first light beam LB11 when it is incident on the first reflective surface RS11. The object (not shown) is disposed on the object side emitting a second light beam LB12. The second light beam LB12 passes sequentially through the second stop ST12 and the second incident area InA12, and then is incident on the fourth reflective surface RS14. The fourth reflective surface RS14 reflects the second light beam LB12, so that the second light beam LB12 is incident on the third reflective surface RS13. The third reflective surface RS13 reflects the second light beam LB12, so that the second light beam LB12 exits from the second exit area OutA12. The propagation direction of the second light beam LB12 after being reflected by the third reflective surface RS13 is the same as the propagation direction of the second light beam LB12 when it is incident on the fourth reflective surface RS14. The first light beam LB11 has just been emitted from the first exit area OutA11, the second light beam LB12 has just been emitted from the second exit area OutA12, and both of them do not intersect. The first light beam LB11 and the second light beam LB12 then enter the lens assembly LA1 and finally form an image on an image plane IMA1. With the above design of the stops ST11, ST12, the reflective surfaces RS11, RS12, RS13, RS14, the lens assembly LA1, and at least one of the conditions (1)-(5) are satisfied, the stereoscopic imaging system 1 can have an effective increased working distance and an effective increased back focal length.

Table 1 shows the parameters and condition values for conditions (1)-(5) in accordance with the stereoscopic imaging system 1 of the first embodiment. It can be seen from Table 1 that the stereoscopic imaging system 1 of the first embodiment satisfies the conditions (1)-(5).

TABLE 1

| | | | | | | | |
|---|---|---|---|---|---|---|---|
| L1 | 16 | mm | L2 | 22.63 | mm | FOV | 12 |
| | | | | | | | degrees |
| WD | 15 | mm | L4 | 16 | mm | | |
| FOV/L1 | 0.75 | degree/mm | (L1 × | 24.14 | mm | L2/L1 | 1.41 |
| | | | L2)/WD | | | | |

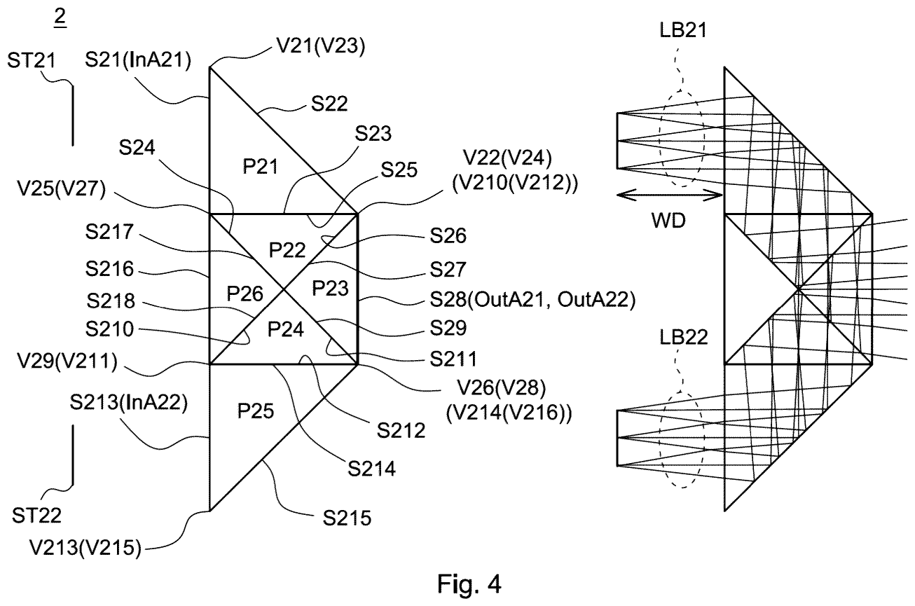

A detailed description of a stereoscopic imaging system in accordance with a second embodiment of the invention is as follows. Referring to FIG. 3 and FIG. 4, the stereoscopic imaging system 2 includes a first stop ST21, a second stop ST22, a first prism P21, a second prism P22, a third prism P23, a fourth prism P24, a fifth prism P25, a sixth prism P26, and a lens assembly LA2, all of which are arranged in order from an object side to an image side along an optical axis OA2. The first prism P21 includes a first surface S21, a second surface S22, and a third surface S23. The second prism P22 includes a fourth surface S24, a fifth surface S25, and a sixth surface S26. The third prism P23 includes a seventh surface S27, an eighth surface S28, and a ninth surface S29. The fourth prism P24 includes a tenth surface S210, an eleventh surface S211, and a twelfth surface S212. The fifth prism P25 includes a thirteenth surface S213, a fourteenth surface S214, and a fifteenth surface S215. The sixth prism includes a sixteenth surface S216, a seventeenth surface S217, and an eighteenth surface S218. The third surface S23 of the first prism P21 connects the fifth surface S25 of the second prism P22. The sixth surface S26 of the second prism P22 connects the seventh surface S27 of the third prism P23. The ninth surface S29 of the third prism P23 connects the eleventh surface S211 of the fourth prism P24. The twelfth surface S212 of the fourth prism P24 connects the fourteenth surface S214 of the fifth prism. The tenth surface S210 of the fourth prism P24 connects the eighteenth surface S218 of the sixth prism P26. The seventeenth surface S217 of the sixth prism P26 connects the fourth surface S24 of the second prism P22. The first prism P21 and the fifth prism P25 are disposed on both sides of the optical axis OA2, wherein the optical axis OA2 is the axis of symmetry. The second prism P22 and the fourth prism P24 are disposed on both sides of the optical axis OA2, wherein the optical axis OA2 is the axis of symmetry. The first prism P21 and the second prism P22 are disposed on one side of the optical axis OA2, and the fourth prism P24 and the fifth prism P25 are disposed on the other side of the optical axis OA2. The second prism P22, the third prism P23, the fourth prism P24, and the sixth prism P26 are interconnected to form a beam combining prism. The second surface S22 includes a first point V21, a second point V22, a third point V23, and a fourth point V24. The fourth surface S24 includes a fifth point V25 and a seventh point V27, or the seventeenth surface S217 includes a fifth point V25 and a seventh point V27. The ninth surface S29 includes a sixth point V26 and an eighth point V28, or the eleventh surface S211 includes a sixth point V26 and an eighth point V28. The first point V21, the fifth point V25, the seventh point V27, and the third point V23 form the first surface S21. The first surface S21 is the first incident area InA21. The second point V22, the sixth point V26, the eighth point V28, and the fourth point V24 form the eighth surface S28. The eighth surface S28 is the first exit area OutA21. The tenth surface S210 includes a ninth point V29 and an eleventh point V211, or the eighteenth surface S218 includes a ninth point V29 and an eleventh point V211. The seventh surface S27 includes a tenth point V210 and a twelfth point V212, or the sixth surface S26 includes a tenth point V210 and a twelfth point V212. The fifteenth surface S215 includes a thirteenth point V213, a fourteenth point V214, a fifteenth point V215, and a sixteenth point V216. The ninth point V29, the thirteenth point V213, the fifteenth point V215, and the eleventh point V211 form the thirteenth surface S213. The thirteenth surface S213 is the second incident area InA12. The tenth point V210, the fourteenth point V214, the sixteenth point V216, and the twelfth point V212 form the eighth surface S28. The eighth surface S28 is also the second exit area OutA22. The lens assembly LA2 is the same as the lens assembly LA1 of the first embodiment, so that it is not described again. In operation, an object (not shown) is disposed on the object side emitting a first light beam LB21. The first light beam LB21 passes sequentially through the first stop ST21 and the first surface S21 (the first incident area InA21), and then is incident on the second surface S22. The second surface S22 reflects the first light beam LB21 (the second surface S22 is the first reflective surface which is one of the inclined surfaces of the first prism P21), so that the first light beam LB21 is incident and passes through the third surface S23. A partial first light beam LB21 is incident on the fourth surface S24, then is reflected by the fourth surface S24 and is incident on and passes through the sixth surface S26 and the seventh surface S27, then is incident on the eighth surface S28, and exits the third prism P23 from the eighth surface S28 (the first exit area OutA21). Another partial first light beam LB21 is incident on and passes sequentially through the sixth surface S26 and the seventh surface S27, then is incident on the ninth surface S29. The ninth surface S29 reflects the another partial first light beam LB21, so that the another partial first light beam LB21 is incident on the eighth surface S28 and exits the third prism P23 from the eighth surface S28 (the first exit area OutA21). The fourth surface S24 and the ninth surface S29 form the second reflective surface (one of the beam splitting surfaces of the beam combining prism). The propagation direction of the first light beam LB21 after exiting the eighth surface S28 is the same as the propagation direction of the first light beam LB21 when it is incident on the first surface S21. The aforementioned ninth surface S29 reflects the another partial first light beam LB21 can also be modified, so that the another partial first light beam LB21 directly penetrates the ninth surface S29, then is incident on the eleventh surface S211. The eleventh surface S211 reflects the another partial first light beam LB21, so that the another partial first light beam LB21 is incident on and penetrates the ninth surface S29, then is incident on the eighth surface S28, and exits the third prism P23 from the eighth surface S28 (the first exit area OutA21). The fourth surface S24 and the eleventh surface S211 form the second reflective surface (one of the beam splitting surfaces of the beam combining prism). The object (not shown) disposed on the object side emitting a second light beam LB22. The second light beam LB22 is incident on the fifth prism P25 through the thirteenth surface S213 (the second incident area InA22), then is incident on the fifteenth surface S215. The fifteenth surface S215 reflects the second light beam LB22 (the fifteenth surface S215 is the fourth reflective surface which is one of the inclined surfaces of the fifth prism P25), so that the second light beam LB22 is incident on and passes sequentially through the fourteenth surface S214 and the twelfth surface S212. A partial second light beam LB22 is incident on the tenth surface S210, then is reflected by the tenth surface S210 and is incident on and passes sequentially through the eleventh surface S211 and the ninth surface S29, then is incident on the eighth surface S28, and exits the third prism P23 from the eighth surface S28 (the second exit area OutA22). Another partial second light beam LB22 is incident on and passes sequentially through the eleventh surface S211 and the ninth surface S29, then is incident on the seventh surface S27. The seventh surface S27 reflects the another partial second light beam LB22, so that the another partial second light beam LB22 is incident on the eighth surface S28, and exits the third prism P23 from the eighth surface S28 (the second exit area OutA22). The tenth surface S210 and the seventh surface S27 form the third reflective surface (another one of the beam splitting surfaces of the beam combining prism). The propagation direction of the second light beam LB22 after exiting the eighth surface S28 is the same as the propagation direction of the second light beam LB22 when it is incident on the thirteenth surface S213. The aforementioned seventh surface S27 reflects the another partial second light beam LB22 can also be modified, so that the another partial second light beam LB22 directly penetrates the seventh surface S27 and then is incident on the sixth surface S26. The sixth surface S26 reflects the another partial second light beam LB22, so that the another partial second light beam LB22 is incident on and penetrates the seventh surface S27, then is incident on the eighth surface S28, and exits the third prism P23 from the eighth surface S28 (the second exit area OutA22). The tenth surface S210 and the sixth surface S26 form the third reflective surface (another one of the beam splitting surfaces of the beam combining prism). The first light beam LB21 has just been emitted from the eighth surface S28 (the first exit area OutA21), the second light beam LB22 has just been emitted from the eighth surface S28 (the second exit area OutA22), and both of them intersect. The first light beam LB21 and the second light beam LB22 then enter the lens assembly LA2 and finally form an image on an image plane IMA2. With the above design of the stops ST21, ST22, the prisms P21, P22, P23, P24, P25, P26, the lens assembly LA2, and at least one of the conditions (1)-(5) are satisfied, the stereoscopic imaging system 2 can have an effective increased working distance and an effective increased back focal length. It should be noted that the partial first light beam LB21 and the another partial first light beam LB21, or the partial second light beam LB22 and the another partial second light beam LB22 mentioned above are for the convenience of explaining that the subsequent reflection caused by the light beam is incident on different position of the inclined plane will pass through different prism. Therefore, the partial first light beam LB21 and the another partial first light beam LB21 belong to the first light beam LB21. The same applies to the following descriptions and is not described again.

Table 2 shows the parameters and condition values for conditions (1)-(5) in accordance with the stereoscopic imaging system 2 of the second embodiment. It can be seen from Table 2 that the stereoscopic imaging system 2 of the second embodiment satisfies the conditions (1)-(5).

TABLE 2

| | | | | | | |
|---|---|---|---|---|---|---|
| L1 | 21.3 | mm | L2 | 30.12 mm | FOV | 18 degrees |
| WD | 15 | mm | L4 | 21.2 mm | | |
| FOV/L1 | 0.85 | degree/mm | (L1 × | 42.77 mm | L2/L1 | 1.41 |
| | | | L2)/WD | | | |

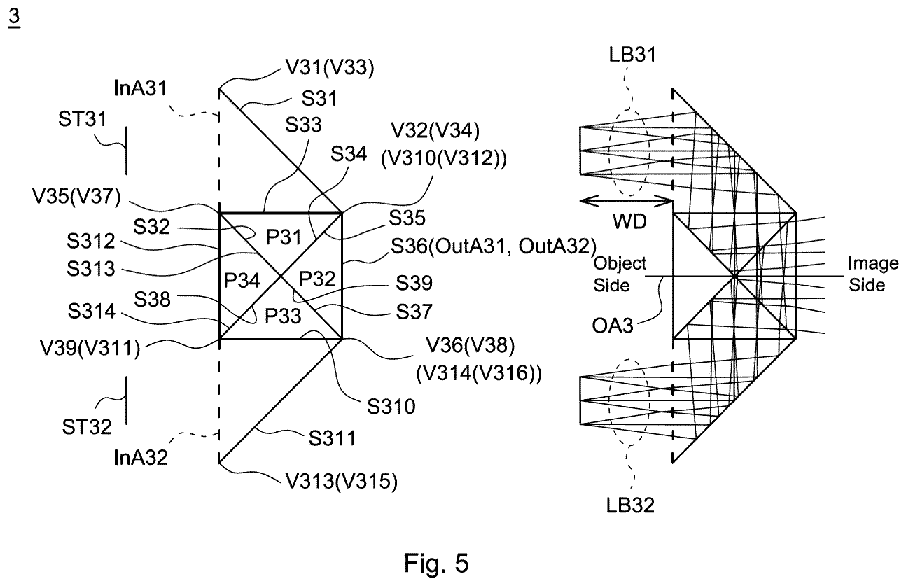

A detailed description of a stereoscopic imaging system in accordance with a third embodiment of the invention is as follows. Referring to FIG. 5, FIG. 5 is a partial schematic diagram of a stereoscopic imaging system in accordance with a third embodiment of the invention. The stereoscopic imaging system 3 includes a first stop ST31, a second stop ST32, a first surface S31, a first prism P31, a second prism P32, a third prism P33, a fourth prism P34, an eleventh surface S311, and a lens assembly LA3 (not shown), all of which are arranged in order from an object side to an image side along an optical axis OA3. The first prism P31 includes a second surface S32, a third surface S33, and a fourth surface S34. The second prism P32 includes a fifth surface S35, a sixth surface S36, and a seventh surface S37. The third prism P33 includes an eighth surface S38, a ninth surface S39, and a tenth surface S310. The fourth prism P34 includes a twelfth surface S312, a thirteenth surface S313, and a fourteenth surface S314. The first surface S31 connects the first prism P31, such that the first surface S31 faces the third surface S33, and there is an inclination angle between the first surface S31 and the third surface S33. The second surface S32 of the first prism P31 connects the thirteenth surface S313 of the fourth prism P34, and the fourth surface S34 connects the fifth surface S35 of the second prism P32. The ninth surface S39 of the third prism P33 connects the seventh surface S37 of the second prism P32, and the eighth surface S38 connects the fourteenth surface S314 of the fourth prism P34. The first prism P31, the second prism P32, the third prism P33, and the fourth prism P34 are interconnected to form a beam combining prism. The eleventh surface S311 connects the third prism P33, so that the eleventh surface S311 faces the tenth surface S310, and there is an inclination angle between the eleventh surface S311 and the tenth surface S310. The first prism P31 and the third prism P33 are disposed on both sides of the optical axis OA3, wherein the optical axis OA3 is the axis of symmetry. The first surface S31 and the eleventh surface S311 are disposed on both sides of the optical axis OA3, wherein the optical axis OA3 is the axis of symmetry. The first surface includes a first point V31, a second point V32, a third point V33, and a fourth point V34. The second surface S32 includes a fifth point V35 and a seventh point V37. The seventh surface S37 includes a sixth point V36 and an eighth point V38. The first point V31, the fifth point V35, the seventh point V37, and the third point V33 form the first incident area InA31. The second point V32, the sixth point V36, the eighth point V38, and the fourth point V34 form the sixth surface S36. The sixth surface S36 is the first exit area OutA31. The eighth surface S38 includes a ninth point V39 and an eleventh point V311. The fifth surface S35 includes a tenth point V310 and a twelfth point V312. The eleventh surface S311 includes a thirteenth point V313, a fourteenth point V314, a fifteenth point V315, and a sixteenth point V316. The ninth point V39, the thirteenth point V313, the fifteenth point V315, and the eleventh point V311 form the second incident area InA32. The tenth point V310, the fourteenth point V314, the sixteenth point V316, and the twelfth point V312 form the sixth surface S36. The sixth surface S36 is the second exit area OutA32. The lens assembly LA3 is the same as the lens assembly LA1 of the first embodiment, so that it is not described again. In operation, an object (not shown) is disposed on the object side emitting a first light beam LB31. The first light beam LB31 passes sequentially through the first stop ST31 and the first incident area InA31 and then is incident on the first surface S31. The first surface S31 reflects the first light beam LB31 (the first surface S31 is the first reflective surface), so that the first light beam LB31 is incident on and passes through the third surface S33. A partial first light beam LB31 is incident on the second surface S32, then is reflected by the second surface S32 and is incident on and passes through the fourth surface S34 and the fifth surface S35, then is incident on the sixth surface S36, and exits the second prism P32 from the sixth surface S36 (the first exit area OutA31). Another partial first light beam LB31 is incident on and passes sequentially through the fourth surface S34 and the fifth surface S35, then is incident on the seventh surface S37. The seventh surface S37 reflects the another partial first light beam LB31, so that the another partial first light beam LB31 is incident on the sixth surface S36, and exits the second prism P32 from the sixth surface S36 (the first exit area OutA31). The second surface S32 and the seventh surface S37 form the second reflective surface (one of the beam splitting surfaces of the beam combining prism). The propagation direction of the first light beam LB31 after exiting the sixth surface S36 is the same as the propagation direction of the first light beam LB31 when it is incident on the first surface S31. The object (not shown) is disposed on the object side emitting a second light beam LB32. The second light beam LB32 passes sequentially through the first stop ST32 and the second incident area InA32, then is incident on the eleventh surface S311. The eleventh surface S311 reflects the second light beam LB32 (the eleventh surface S311 is the fourth reflective surface), so that the second light beam LB32 is incident on and passes through the tenth surface S310. A partial second light beam LB32 is incident on the eighth surface S38, then is reflected by the eighth surface S38 and passes sequentially through the ninth surface S39 and the seventh surface S37, then is incident on the sixth surface S36, and exits the second prism P32 from the sixth surface S36 (the second exit area OutA32). Another partial second light beam LB32 is incident on and passes sequentially through the ninth surface S39 and the seventh surface S37, then is incident on the fifth surface S35. The fifth surface S35 reflects the another partial second light beam LB32, so that the another partial second light beam LB32 is incident on the sixth surface S36, and exits the second prism P32 from the sixth surface S36 (the second exit area OutA32). The eighth surface S38 and the fifth surface S35 form the third reflective surface (one of the beam splitting surfaces of the beam combining prism). The propagation direction of the second light beam LB32 after exiting the sixth surface S36 is the same as the propagation direction of the second light beam LB32 when it is incident on the eleventh surface S311 (the fourth reflective surface). The first light beam LB31 has just been emitted from the sixth surface S36 (the first exit area OutA31), the second light beam LB32 has just been emitted from the sixth surface S36 (the second exit area OutA32), and both of them intersect. The first light beam LB31 and the second light beam LB32 then enter the lens assembly LA3 and finally form an image on an image plane IMA3 (not shown). With the above design of the stops ST31, ST32, the first surface S31, the eleventh surface S311, the prisms P31, P32, P33, P34, the lens assembly LA3, and at least one of the conditions (1)-(5) are satisfied, the stereoscopic imaging system 3 can have an effective increased working distance and an effective increased back focal length.

Table 3 shows the parameters and condition values for conditions (1)-(5) in accordance with the stereoscopic imaging system 3 of the third embodiment. It can be seen from Table 3 that the stereoscopic imaging system 3 of the third embodiment satisfies the conditions (1)-(5).

TABLE 3

| | | | | | | |
|---|---|---|---|---|---|---|
| L1 | 21.3 | mm | L2 | 30.12 mm | FOV | 13 degrees |
| WD | 15 | mm | L4 | 21.3 mm | | |
| FOV/L1 | 0.61 | degree/mm | (L1 × | 42.77 mm | L2/L1 | 1.41 |
| | | | L2)/WD | | | |

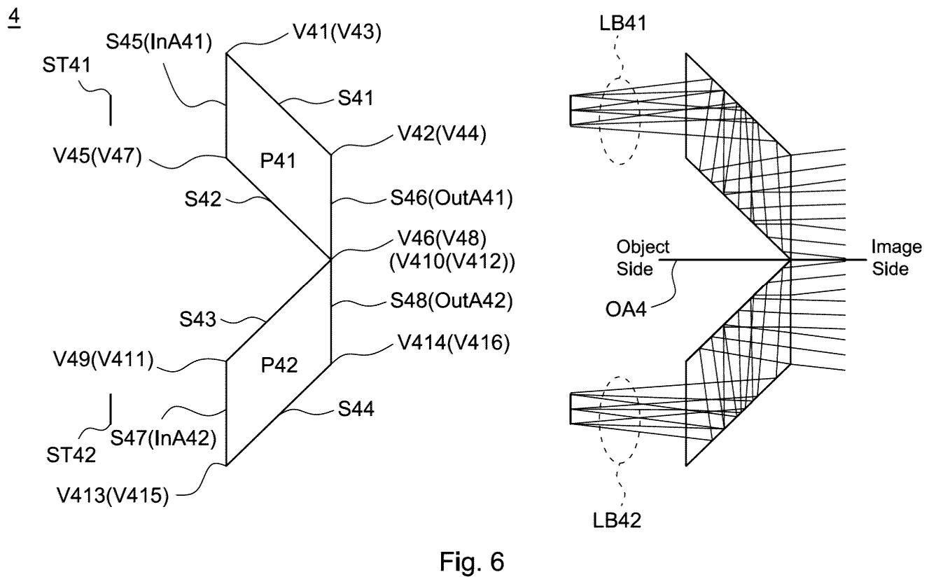

A detailed description of a stereoscopic imaging system in accordance with a fourth embodiment of the invention is as follows. Referring to FIG. 6, FIG. 6 is a partial schematic diagram of a stereoscopic imaging system in accordance with a fourth embodiment of the invention. The stereoscopic imaging system 4 includes a first stop ST41, a second stop ST42, a first prism P41, a second prism P42, and a lens assembly LA4 (not shown), all of which are arranged in order from an object side to an image side along an optical axis OA4. The first prism P41 is a parallelogram prism and includes a fifth surface S45, a first surface S41, a sixth surface S46, and a second surface S42. The fifth surface S45 faces the sixth surface S46. The first surface S41 faces the second surface S42. The second prism P42 is a parallelogram prism and includes a seventh surface S47, a third surface S43, an eighth surface S48, and a fourth surface S44. The seventh surface S47 faces the eighth surface S48. The third surface S43 faces the fourth surface S44. The first prism P41 connects the second prism P42, such that the second surface S42 faces the third surface S43, and there is an inclination angle between the second surface S42 and the third surface S43. The first prism P41 and the second prism P42 are disposed on both sides of the optical axis OA4, wherein the optical axis OA4 is the axis of symmetry. The first surface S41 includes a first point V41, a second point V42, a third point V43, and a fourth point V44. The second surface S42 includes a fifth point V45, a sixth point V46, a seventh point V47, and an eighth point V48. The first point V41, the fifth point V45, the third point V43, and the seventh point V47 form the fifth surface S45 (the fifth surface S45 is the first incident area InA41). The second point V42, the sixth point V46, the eighth point V48, and the fourth point V44 form the sixth surface S46 (the sixth surface S46 is the first exit area OutA41). The third surface S43 includes a ninth point V49, a tenth point V410, an eleventh point V411, and a twelfth point V412. The fourth surface S44 includes a thirteenth point V413, a fourteenth point V414, a sixteenth point V416, and a fifteenth point V415. The ninth point V49, the thirteenth point V413, the eleventh point V411, and the fifteenth point V415 form the fourth surface S47 (the fourth surface S47 is the second incident area InA42). The tenth point V410, the fourteenth point V414, the twelfth point V412, and the sixteenth point V416 form the eighth surface S48 (the eighth surface S48 is the second exit area OutA42). The lens assembly LA4 is the same as the lens assembly LA1 of the first embodiment, so that it is not described again. In operation, an object (not shown) is located on the object side emitting a first light beam LB41. The first light beam LB41 passes sequentially through the first stop ST41 and the fourth surface S45 (the first incident area InA41) and then is incident on the first surface S41. The first surface S41 reflects the first light beam LB41 (the first surface S41 is the first reflective surface), so that the first light beam LB41 is incident on the second surface S42, then is reflected by the second surface S42 (the second surface S42 is the second reflective surface), then is incident on the sixth surface S46, and exits the first prism P41 from the sixth surface S46 (the first exit area OutA41). The propagation direction of the first light beam LB41 after exiting the sixth surface S46 is the same as the propagation direction of the first light beam LB41 when it is incident on the fourth surface S45 (the first incident area InA41). The object (not shown) disposed on the object side emitting a second light beam LB42. The second light beam LB42 passes sequentially through the second stop ST42 and the seventh surface S47 (the second incident area InA42) and then is incident on the fourth surface S44. The fourth surface S44 reflects the second light beam LB42 (the fourth surface S44 is the fourth reflective surface), so that the second light beam LB42 is incident on the third surface S43, then is reflected by the third surface S43 (the third surface S43 is the third reflective surface), then is incident on the eighth surface S48, and exits the second prism P42 from the eighth surface S48 (the second exit area OutA42). The propagation direction of the second light beam LB42 after exiting the eighth surface S48 is the same as the propagation direction of the second light beam LB42 when it is incident on the seventh surface S47 (the second incident area InA42). The first light beam LB41 has just been emitted from the sixth surface S46 (the first exit area OutA41), the second light beam LB42 has just been emitted from the eighth surface S48 (the second exit area OutA42), and both of them do not intersect. The first light beam LB41 and the second light beam LB42 then enter the lens assembly LA4 (not shown) and finally form an image on an image plane IMA4 (not shown). With the above design of the stops ST41, ST42, the prisms P41, P42, the lens assembly LA4, and at least one of the conditions (1)-(5) are satisfied, the stereoscopic imaging system 4 can have an effective increased working distance and an effective increased back focal length.

Table 4 shows the parameters and condition values for conditions (1)-(5) in accordance with the stereoscopic imaging system 4 of the fourth embodiment. It can be seen from Table 4 that the stereoscopic imaging system 4 of the fourth embodiment satisfies the conditions (1)-(5).

TABLE 4

| | | | | | | | |
|---|---|---|---|---|---|---|---|
| L1 | 16 | mm | L2 | 22.63 | mm | FOV | 16 degrees |
| WD | 15 | mm | L4 | 16 | mm | | |
| FOV/L1 | 1.0 | degree/mm | (L1 × | 24.14 | mm | L2/L1 | 1.41 |
| | | | L2)/WD | | | | |

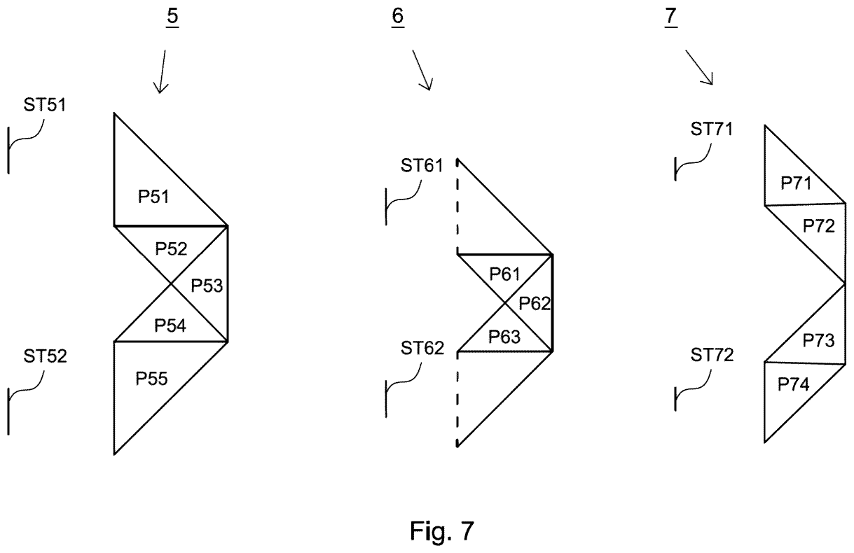

A detailed description of a stereoscopic imaging system in accordance with a fifth embodiment of the invention is as follows. Referring to FIG. 7, the left side of FIG. 7 is a partial schematic diagram of a stereoscopic imaging system in accordance with a fifth embodiment of the invention. FIG. 4 shows that the stereoscopic imaging system 2 of the second embodiment includes six prisms which are the first prism P21, the second prism P22, the third prism P23, the fourth prism P24, the fifth prism P25, and the sixth prism P26. By removing the sixth prism P26 (refer to FIG. 4), the stereoscopic imaging system 5 of the fifth embodiment can be obtained. The stereoscopic imaging system 5 includes five prisms which are a first prism P51, a second prism P52, a third prism P53, a fourth prism P54, and a fifth prism P55.

A detailed description of a stereoscopic imaging system in accordance with a sixth embodiment of the invention is as follows. Referring to FIG. 7, the middle side of FIG. 7 is a partial schematic diagram of a stereoscopic imaging system in accordance with a sixth embodiment of the invention. FIG. 5 shows that the stereoscopic imaging system 3 of the third embodiment includes four prisms which are the first prism P31, the second prism P32, the third prism P33, and the fourth prism P34. By removing the fourth prism P34 (refer to FIG. 5), the stereoscopic imaging system 6 of the sixth embodiment can be obtained. The stereoscopic imaging system 6 includes three prisms which are a first prism P61, a second prism P62, and a third prism P63.

A detailed description of a stereoscopic imaging system in accordance with a seventh embodiment of the invention is as follows. Referring to FIG. 7, the right side of FIG. 7 is a partial schematic diagram of a stereoscopic imaging system in accordance with a seventh embodiment of the invention. The stereoscopic imaging system 7 of the seventh embodiment can be obtained by modifying the first prism P41 and the second prism P42 of the stereoscopic imaging system 4 of the fourth embodiment (FIG. 6) in such a way that each of the first prism P41 and the second prism P42 are replaced with two prisms. Specifically, the stereoscopic imaging system 7 includes four prisms which are a first prism P71, a second prism P72, a third prism P73, and a fourth prism P74, wherein the inclined surface of the first prism P71 is the first reflective surface, the inclined surface of the second prism P72 is the second reflective surface, the inclined surface of the third prism P73 is the third reflective surface, and the inclined surface of the fourth prism P74 is the fourth reflective surface.

In the first embodiment described above (refer to FIG. 2), the first reflective surface RS11 is formed by the first point V11, the second point V12, the third point V13, and the fourth point V14 (these four points form a plane); the second reflective surface RS12 is formed by the fifth point V15, the sixth point V16, the seventh point V17, and the eighth point V18 (these four points form a plane); the third reflective surface RS13 is formed by the ninth point V19, the tenth point V110, the eleventh point V111, and the twelfth point V112 (these four points form a plane); and the fourth reflective surface RS14 is formed by the thirteenth point V113, the fourteenth point V114, the fifteenth point V115, and the sixteenth point V116 (these four points form a plane). However, it can be understood that the second point V12 and the fourth point V14 of the first reflective surface RS11 can be modified to be the same point, so that the first reflective surface RS11 is formed by the first point V11, the second point V12 (the fourth point V14), and the third point V13 (three points form a plane). Similarly, the second reflective surface RS12 can be modified to be formed by the fifth point V15 (the seventh point V17), the sixth point V16, and the eighth point V18 (three points form a plane), or the first point V11 and the third point V13 of the first reflective surface RS11 can be modified to be the same point, so that the first reflective surface RS11 is formed by the first point V11 (the third point V13), the second point V12, and the fourth point V14 (three points form a plane). Similarly, the second reflective surface RS12 can be modified to be formed by the fifth point V15, the seventh point V17, and the sixth point V16 (the eighth point V18) (three points form a plane); the third reflective surface RS13 is modified to be formed by the ninth point V19, the tenth point V110 (the twelfth point V112), and the eleventh point V111 (three points form a plane), the fourth reflective surface RS14 is modified to be formed by the thirteenth point V113 (the fifteenth point V115), the fourteenth point V114, and the sixteenth point V116 (three points form a plane); or the third reflective surface RS13 is modified to be formed by the ninth point V19 (the eleventh point V111), the tenth point V110, and the twelfth point V112 (three points form a plane), the fourth reflective surface RS14 is modified to be formed by the thirteenth point V113, the fifteenth point V115, and the fourteenth point V114 (the sixteenth point V116) (three points form a plane). With this design, the incident area and the exit area will also be enclosed by three points respectively, which should also fall within the scope of this invention. In other embodiments, a stop may not be provided, or the stop may be disposed between the exit area and the lens assembly.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A stereoscopic imaging system comprising a plurality of reflective surfaces, wherein:
a first reflective surface faces a second reflective surface;
a first incident area is disposed between the first reflective surface and the second reflective surface, and is close to an object side and away from an image side;
a first exit area is disposed between the first incident area and the image side;
a first light beam is emitted from the object side passes through the first incident area and then is incident on the first reflective surface, then is reflected by the first reflective surface and then is incident on the second reflective surface, then is reflected by the second reflective surface and then exits from the first exit area, wherein the propagation direction of the first light beam after reflection by the second reflective surface is the same as the propagation direction of the first light beam when it enters the first reflective surface;
a third reflective surface faces a fourth reflective surface;
a second incident area is disposed between the third reflective surface and the fourth reflective surface, and is close to the object side and away from the image side;
a second exit area is disposed between the second incident area and the image side;
a second light beam is emitted from the object side passes through the second incident area and then is incident on the fourth reflective surface, then is reflected by the fourth reflective surface and then is incident on the third reflective surface, then is reflected by the third reflective surface and then exits from the second exit area, wherein the propagation direction of the second light beam after reflection by the third reflective surface is the same as the propagation direction of the second light beam when it enters the fourth reflective surface;
the first reflective surface is disposed parallel to the second reflective surface;
the third reflective surface is disposed parallel to the fourth reflective surface;
the second reflective surface intersects with the third reflective surface; and
the stereoscopic imaging system satisfies at least one of following conditions:
$$16 mm \leq L 1 \leq 27 mm ;$$
$$16 mm \leq L 4 \leq 27 mm ;$$
$$0.4 degree / mm \leq FOV / L 1 \leq 1.2 degree / mm ;$$
$$19 mm \leq ( L 1 \times L 2 ) / WD \leq 52 mm ;$$
$$1.1 \leq L 2 / L 1 \leq 1.6 ;$$
wherein L1 is a shortest interval between an object side end of the first reflective surface and an object side end of the second reflective surface, L2 is a shortest interval between the object side end of the first reflective surface and an image side end of the first reflective surface, L4 is a shortest interval between the image side end of the first reflective surface and an image side end of the second reflective surface, FOV is a field of view of the stereoscopic imaging system, and WD is a shortest interval between a first stop and the first incident area.

2. The stereoscopic imaging system as claimed in claim 1, wherein:
the first reflective surface comprises a first point, a second point, a third point, and a fourth point;
the second reflective surface comprises a fifth point, a sixth point, a seventh point, and an eighth point;
the first point, the fifth point, the seventh point, and the third point form the first incident area, and the second point, the sixth point, the eighth point, and the fourth point form the first exit area;
the third reflective surface comprises a ninth point, a tenth point, an eleventh point, and a twelfth point;
the fourth reflective surface comprises a thirteenth point, a fourteenth point, a fifteenth point, and a sixteenth point;
the ninth point, the thirteenth point, the fifteenth point, and the eleventh point form the second incident area, and the tenth point, the fourteenth point, the sixteenth point, and the twelfth point form the second exit area.

3. The stereoscopic imaging system as claimed in claim 2, wherein:
the first point and the third point are the same point and the sixth point and the eighth point are the same point, or the fifth point and the seventh point are the same point and the second point and the fourth point are the same point when the first reflective surface and the second reflective surface are planes formed by three points, respectively; and
the ninth point and the eleventh point are the same point and the fourteenth point and the sixteenth point are the same point, or the thirteenth point and the fifteenth point are the same point and the tenth point and the twelfth point are the same point when the third reflective surface and the fourth reflective surface are planes formed by three points, respectively.

4. The stereoscopic imaging system as claimed in claim 3, wherein:
the first reflective surface is formed by a first plane mirror, or by a first surface of a parallelogram prism, or by an inclined surface of a first prism;
the second reflective surface is formed by a second plane mirror, or by a second surface of the parallelogram prism, or by an inclined surface of a second prism, or by a beam splitting surface of a beam combining prism;
the third reflective surface is formed by a third plane mirror, or by a third surface of another parallelogram prism, or by an inclined surface of a third prism, or by another beam splitting surface of the beam combining prism; and
the fourth reflective surface is formed by a fourth plane mirror, or by a fourth surface of the another parallelogram prism, or by an inclined surface of a fourth prism.

5. The stereoscopic imaging system as claimed in claim 2, wherein:
the first reflective surface is formed by a first plane mirror, or by a first surface of a parallelogram prism, or by an inclined surface of a first prism;
the second reflective surface is formed by a second plane mirror, or by a second surface of the parallelogram prism, or by an inclined surface of a second prism, or by a beam splitting surface of a beam combining prism;
the third reflective surface is formed by a third plane mirror, or by a third surface of another parallelogram prism, or by an inclined surface of a third prism, or by another beam splitting surface of the beam combining prism; and
the fourth reflective surface is formed by a fourth plane mirror, or by a fourth surface of the another parallelogram prism, or by an inclined surface of a fourth prism.

6. A stereoscopic imaging system comprising a plurality of prisms, wherein:
a first prism comprises a first surface, a second surface, and a third surface;
a second prism comprises a fourth surface, a fifth surface, and a sixth surface;
a third prism comprises a seventh surface, an eighth surface, and a ninth surface;
a fourth prism comprises a tenth surface, an eleventh surface, and a twelfth surface;
a fifth prism comprises a thirteenth surface, a fourteenth surface, and a fifteenth surface;
the first surface of the first prism forms the first incident area, the thirteenth surface of the fifth prism forms the second incident area, and the eighth surface of the third prism forms an exit area;
the third surface of the first prism connects the fifth surface of the second prism, the sixth surface of the second prism connects the seventh surface of the third prism, the ninth surface of the third prism connects the eleventh surface of the fourth prism, and the twelfth surface of the fourth prism connects the fourteenth surface of the fifth prism;
a first reflective surface is formed by the second surface of the first prism;
a second reflective surface is formed by the fourth surface of the second prism and the ninth surface of the third prism, or by the fourth surface of the second prism and the eleventh surface of the fourth prism;
a third reflective surface is formed by the sixth surface of the second prism and the tenth surface of the fourth prism, or by the seventh surface of the third prism and the tenth surface of the fourth prism;
a fourth reflective surface is formed by the fifteenth surface of the fifth prism;
a first light beam is emitted from the object side passes through the first incident area and then is incident on the first reflective surface, then is reflected by the first reflective surface and then is incident on the second reflective surface, then is reflected by the second reflective surface and then exits from the exit area, wherein the propagation direction of the first light beam after reflection by the second reflective surface is the same as the propagation direction of the first light beam when it enters the first reflective surface; and
a second light beam is emitted from the object side passes through the second incident area and then is incident on the fourth reflective surface, then is reflected by the fourth reflective surface and then is incident on the third reflective surface, then is reflected by the third reflective surface and then exits from the exit area, wherein the propagation direction of the second light beam after reflection by the third reflective surface is the same as the propagation direction of the second light beam when it enters the fourth reflective surface.

7. The stereoscopic imaging system as claimed in claim 6, further comprising a sixth prism, wherein:
the sixth prism comprises a sixteenth surface, a seventeenth surface, and an eighteenth surface, wherein the sixteenth surface faces the object side, the seventeenth surface connects the fourth surface of the second prism, and the eighteenth surface connects the tenth surface of the fourth prism; and
the second reflective surface is formed by the seventeenth surface and the eleventh surface of the fourth prism and the third reflective surface is formed by the eighteenth surface and the sixth surface of the second prism when the sixth prism is disposed.

8. The stereoscopic imaging system as claimed in claim 6, wherein the stereoscopic imaging system satisfies at least one of following conditions:
$$16 mm \leq L 1 \leq 27 mm ;$$
$$16 mm \leq L 4 \leq 27 mm ;$$
$$0.4 degree / mm \leq FOV / L 1 \leq 1.2 degree / mm ;$$
$$19 mm \leq ( L 1 \times L 2 ) / WD \leq 52 mm ;$$
$$1.1 \leq L 2 / L 1 \leq 1.6 ;$$
wherein L1 is a shortest interval between an object side end of the first reflective surface and an object side end of the second reflective surface, L2 is a shortest interval between the object side end of the first reflective surface and an image side end of the first reflective surface, L4 is a shortest interval between the image side end of the first reflective surface and an image side end of the second reflective surface, FOV is a field of view of the stereoscopic imaging system, and WD is a shortest interval between a first stop and the first incident area.

9. A stereoscopic imaging system comprising a plurality of reflective surfaces, wherein:
a first reflective surface comprises a first point, a second point, a third point, and a fourth point;
a second reflective surface comprises a fifth point, a sixth point, a seventh point, and an eighth point;
the first reflective surface faces the second reflective surface, such that the first point, the fifth point, the seventh point, and the third point form a first incident area, and the second point, the sixth point, the eighth point, and the fourth point form a first exit area;
a first light beam is emitted from the object side passes through the first incident area and then is incident on the first reflective surface, then is reflected by the first reflective surface and then is incident on the second reflective surface, then is reflected by the second reflective surface and then exits from the first exit area, wherein the propagation direction of the first light beam after reflection by the second reflective surface is the same as the propagation direction of the first light beam when it enters the first reflective surface;
the third reflective surface comprises a ninth point, a tenth point, an eleventh point, and a twelfth point;
the fourth reflective surface comprises a thirteenth point, a fourteenth point, a fifteenth point, and a sixteenth point;
the third reflective surface faces the fourth reflective surface, such that the ninth point, the thirteenth point, the fifteenth point, and the eleventh point form a second incident area, and the tenth point, the fourteenth point, the sixteenth point, and the twelfth point form a second exit area;
a second light beam is emitted from the object side passes through the second incident area and then is incident on the fourth reflective surface, then is reflected by the fourth reflective surface and then is incident on the third reflective surface, then is reflected by the third reflective surface and then exits from the second exit area, wherein the propagation direction of the second light beam after reflection by the third reflective surface is the same as the propagation direction of the second light beam when it enters the fourth reflective surface;
the first reflective surface is disposed parallel to the second reflective surface;
the third reflective surface is disposed parallel to the fourth reflective surface;
an end of the second reflective surface comprises the sixth point and the eighth point, an end of the third reflective surface comprises a tenth point and the twelfth point, the sixth point connects the tenth point, the eighth point connects the twelfth point, and another end of the second reflective surface comprises the fifth point and the seventh point and is disposed away from the third reflective surface.

10. The stereoscopic imaging system as claimed in claim 9, wherein:
the first reflective surface and the second reflective surface are respectively a first surface and a second surface of a first prism, wherein the first prism further comprises a fifth surface and a sixth surface, the first surface faces the second surface, the fifth surface faces the sixth surface, the fifth surface forms the first incident area, and the sixth surface forms the first exit area; and
the third reflective surface and the fourth reflective surface are respectively a third surface and a fourth surface of a second prism, wherein the second prism further comprises a seventh surface and an eighth surface, the third surface faces the fourth surface, the seventh surface faces the eighth surface, the seventh surface forms the second incident area, the eighth surface forms the second exit area, and the eighth surface is adjacent to the sixth surface.

11. The stereoscopic imaging system as claimed in claim 9, wherein the stereoscopic imaging system satisfies at least one of following conditions:
$$16 mm \leq L 1 \leq 27 mm ;$$
$$16 mm \leq L 4 \leq 27 mm ;$$
$$0.4 degree / mm \leq FOV / L 1 \leq 1.2 degree / mm ;$$
$$19 mm \leq ( L 1 \times L 2 ) / WD \leq 52 mm ;$$
$$1.1 \leq L 2 / L 1 \leq 1.6 ;$$
wherein L1 is a shortest interval between an object side end of the first reflective surface and an object side end of the second reflective surface, L2 is a shortest interval between the object side end of the first reflective surface and an image side end of the first reflective surface, L4 is a shortest interval between the image side end of the first reflective surface and an image side end of the second reflective surface, FOV is a field of view of the stereoscopic imaging system, and WD is a shortest interval between a first stop and the first incident area.

12. A stereoscopic imaging system comprising a plurality of prisms and a plurality of reflective surfaces, wherein:
a first prism comprises a second surface, a third surface, and a fourth surface;
a second prism comprises a fifth surface, a sixth surface, and a seventh surface;
a third prism comprises an eighth surface, a ninth surface, and a tenth surface;
a first reflective surface is a plane mirror and comprises a first surface, wherein an end of the first surface connects the first prism and another end of the first reflective surface is away from the first prism;
the second surface of the first prism and the seventh surface of the second prism forms a second reflective surface, or the second surface of the first prism and the ninth surface of the third prism forms a second reflective surface;
the eighth surface of the third prism and the fourth surface of the first prism forms a third reflective surface, or the eighth surface of the third prism and the fifth surface of the second prism forms a third reflective surface;
a fourth reflective surface is a plane mirror and comprises an eleventh surface, wherein an end of the eleventh surface connects the third prism and another end of the fourth reflective surface is away from the third prism;
a first incident area is disposed between the first reflective surface and the second reflective surface, and is close to an object side and away from an image side;
a second incident area is disposed between the third reflective surface and the fourth reflective surface, and is close to the object side and away from the image side;
the sixth surface of the second prism forms an exit area;
the fourth surface of the first prism connects the fifth surface of the second prism, and the seventh surface of the second prism connects the ninth surface of the third prism;
a first light beam is emitted from the object side passes through the first incident area and then is incident on the first reflective surface, then is reflected by the first reflective surface and then is incident on the second reflective surface, then is reflected by the second reflective surface and then exits from the exit area, wherein the propagation direction of the first light beam after reflection by the second reflective surface is the same as the propagation direction of the first light beam when it enters the first reflective surface; and
a second light beam is emitted from the object side passes through the second incident area and then is incident on the fourth reflective surface, then is reflected by the fourth reflective surface and then is incident on the third reflective surface, then is reflected by the third reflective surface and then exits from the exit area, wherein the propagation direction of the second light beam after reflection by the third reflective surface is the same as the propagation direction of the second light beam when it enters the fourth reflective surface.

13. The stereoscopic imaging system as claimed in claim 12, further comprising a fourth prism, wherein:
the fourth prism comprises a twelfth surface, a thirteenth surface, and a fourteenth surface, wherein the twelfth surface faces the object side, the thirteenth surface connects the second surface of the first prism, and the fourteenth surface connects the eighth surface of the third prism; and
the second reflective surface is formed by the thirteenth surface and the ninth surface of the third prism, and the third reflective surface is formed by the fourteenth surface and the fourth surface of the second prism when the fourth prism is disposed.

14. The stereoscopic imaging system as claimed in claim 12, wherein the stereoscopic imaging system satisfies at least one of following conditions:
$$16 mm \leq L 1 \leq 27 mm ;$$
$$16 mm \leq L 4 \leq 27 mm ;$$
$$0.4 degree / mm \leq FOV / L 1 \leq 1.2 degree / mm ;$$
$$19 mm \leq ( L 1 \times L 2 ) / WD \leq 52 mm ;$$
$$1.1 \leq L 2 / L 1 \leq 1.6 ;$$
wherein L1 is a shortest interval between an object side end of the first reflective surface and an object side end of the second reflective surface, L2 is a shortest interval between the object side end of the first reflective surface and an image side end of the first reflective surface, L4 is a shortest interval between the image side end of the first reflective surface and an image side end of the second reflective surface, FOV is a field of view of the stereoscopic imaging system, and WD is a shortest interval between a first stop and the first incident area.
